(19) United States
(12) Patent Application Publication
(10) Pub. No.: US 2024/0042501 A1
(43) Pub. Date: Feb. 8, 2024

(54) CLEANING SYSTEM FOR CLEANING A FLOOR OF A CLOSED SYSTEM

(71) Applicant: Bristola, LLC, Waukee, IA (US)

(72) Inventor: Jared Burma, Waukee, IA (US)

(21) Appl. No.: 18/451,481

(22) Filed: Aug. 17, 2023

Related U.S. Application Data
(63) Continuation-in-part of application No. 17/648,636, filed on Jan. 21, 2022.
Application No. 17/648,636 is a continuation of application No. 16/783,629, filed on Feb. 6, 2020, now Pat. No. 11,298,731.
Application No. 16/783,629 is a continuation-in-part of application No. 17/982,656, filed on Nov. 8, 2022.
Application No. 17/982,656 is a continuation of application No. 16/868,140, filed on May 6, 2020, now Pat. No. 11,534,045.
(60) Provisional application No. 62/805,785, filed on Feb. 14, 2019.
(60) Provisional application No. 62/843,897, filed on May 6, 2019.
(60) Provisional application No. 63/403,545, filed on Sep. 2, 2022.

(51) Int. Cl. B08B 9/38; C02F 3/28

(52) U.S. Cl. CPC B08B 9/38; C02F 3/2866

(57) ABSTRACT

In one or more arrangements, a cleaning system for cleaning a floor of a closed system is presented which has a cleaner configured to clean the floor of the closed system, and the cleaner enters the closed system at a position located below a surface level created by liquid within the closed system. In one or more arrangements, the cleaning system may contain a gate complex configured to allow selective access into the closed system. In one or more arrangements, the cleaning system may contain a box system and wherein the cleaner is initially positioned at least partially within the interior volume of the box system.

### CROSS REFERENCE TO RELATED APPLICATIONS

This application is a continuation-in-part of U.S. patent application Ser. No. 17/648,636 filed on Jan. 21, 2022, which is a continuation of U.S. patent application Ser. No. 16/783,629, now U.S. Pat. No. 11,298,731, filed on Feb. 6, 2020, which claims the benefit of U.S. Provisional Application No. 62/805,785 filed on Feb. 14, 2019, each of which are hereby incorporated by reference herein in their entireties.

This application is also a continuation-in-part of U.S. patent application Ser. No. 17/982,656 filed on Nov. 8, 2022, which is a continuation of U.S. patent application Ser. No. 16/868,140, now U.S. Pat. No. 11,534,045, filed on May 6, 2020, which claims the benefit of U.S. Provisional Application No. 62/843,897 filed on May 6, 2019, each of which are hereby incorporated by reference herein in their entireties.

This application also claims the benefit of U.S. Provisional Application No. 63/403,545 filed on Sep. 2, 2022, which is hereby incorporated by reference herein in its entirety.

### FIELD OF THE DISCLOSURE

This disclosure relates to a cleaning system. More specifically, this disclosure relates to a cleaning system which allows for the cleaning of floors of a closed system containing liquid.

### Overview of the Disclosure:

Removal of waste material from floors of a closed system that are inaccessible during operation (inaccessible floors) conventionally requires halting operations to remove the waste material. For example, a floor may be inaccessible due to coverage with liquid, such as the floor of an anaerobic digester tank or anaerobic lagoon. Alternatively, a floor may be inaccessible during operation due to the presence of animals, such as in hog barns or dairy barns.

For optimal performance waste accumulation on the inaccessible floor must be removed. Waste accumulates on an inaccessible floor under normal operating conditions. For example, with respect to inaccessible floors of anaerobic digester tanks or lagoons, the process of anaerobic digestion produces waste. During anaerobic digestion microorganisms (e.g. acetogenic bacteria, archaea) breakdown organic matter into biogas (e.g. methane, carbon dioxide) and solid and liquid digested material (e.g. waste) having elemental nutrients, such as nitrogen, phosphorus, and potassium. Biogas is used as a fuel for combustion and energy production. The waste may be further processed for other uses (e.g. fertilizer), may be recycled back into the digester, or may be discarded.

As anaerobic digestion is carried out in the closed system of an anaerobic digester tank or lagoon that is sealed from the presence of oxygen, the anaerobic digester tank or lagoon fills with waste. This leads to reduced volume for anaerobic digestion to take place, with volume for anaerobic digestion reducing continuously as anaerobic digestion continues. Eventually digester tanks and lagoons require cleaning to remove the waste to maximize volume for anaerobic digestion to take place and to maintain the health of the microorganisms carrying out anaerobic digestion.

Conventional methods for cleaning anaerobic digester tanks and lagoons typically require manual cleaning, whereby production is first shut down, and the anaerobic tank or lagoon is vented and drained. After venting and draining, manual cleaning requires that a human enter the tank or lagoon to assist raking digested contents toward a vacuum where they can be removed. This manual process is both time consuming and hazardous.

The manual process of cleaning a digester tank on average takes at least two weeks, with additional time required to re-seed the tank with microorganisms to restart anaerobic digestion. Not only does production cease all together during this cleaning period, but because cleaning requires shutting down the entire digester operation, digester tanks tend to be cleaned less frequently. Less frequent cleaning means that a digester tank operates at sub-optimal volume.

The manual process of cleaning a digester tank is hazardous for humans. Venting the tank requires releasing explosive and hazardous gasses that may be poisonous to humans (sulfuric acid and ammonia). Moreover, it is dangerous to put a human in a digester tank, as they encounter hazards in a confined space handling mechanical equipment.

In an alternative example, inaccessible floors that are covered with livestock accumulate waste from livestock. This waste accumulation leads to poor conditions for the livestock and unwanted odor. Conventional methods for cleaning inaccessible floors with livestock require either removing the livestock to remove waste, such as with a pressure washer, or manual cleaning around the livestock. Both of these methods are time consuming and require a large amount of manual labor.

It is therefore desirable to have a system to provide access to inaccessible floors (floors of a closed system) for cleaning without requiring shutting down operations to increase operational production. It is further desirable that the system may be retrofitted to an existing closed system to allow cleaning without discharging liquid from the inaccessible floor. Finally, it is desirable to not require physical human entry into the closed system during cleaning to reduce the risk of injury and death and to minimize manual expenditure of labor.

Therefore, for all the reasons stated above, and the reasons stated below, there is a need in the art for cleaning system for cleaning a floor of a closed system. Thus, it is a primary objective of the disclosure to provide a cleaning system that improves upon the state of the art.

Another objective of the disclosure is to provide a cleaning system which is safe to operate.

Yet another objective of the disclosure is to provide a cleaning system which is relatively easy to build.

Another objective of the disclosure is to provide a cleaning system which is relatively friendly to build.

Yet another objective of the disclosure is to provide a cleaning system which can be built relatively quickly and efficiently.

Another objective of the disclosure is to provide a cleaning system which is easy to operate.

Yet another objective of the disclosure is to provide a cleaning system which is relatively cost friendly to manufacture.

Another objective of the disclosure is to provide a cleaning system which is relatively easy to transport.

Yet another objective of the disclosure is to provide a cleaning system which is aesthetically appealing.

Another objective of the disclosure is to provide a cleaning system which is robust.

Another objective of the disclosure is to provide a cleaning system which is relatively inexpensive.

Yet another objective of the disclosure is to provide a cleaning system which is not easily susceptible to wear and tear.

Another objective of the disclosure is to provide a cleaning system which has a long useful life.

Yet another objective of the disclosure is to provide a cleaning system which is efficient to use and operate.

These and other objects, features, or advantages of the disclosure will become apparent from the specification, figures, and claims.

### SUMMARY OF THE DISCLOSURE

In one or more arrangements, a cleaning system for cleaning a floor of a closed system containing liquid is presented which has a cleaner. In one or more arrangements, the cleaner is configured to clean the floor of the closed system, the cleaner is configured to selectively enter and exit the closed system, and the cleaner enters the closed system at a position located below a surface level created by the liquid within the closed system. In one or more arrangements, the cleaner is attached to a waste discharge line and the waste discharge line is configured to transfer material away from the closed system. In one or more arrangements, the cleaner may be a remote controlled cleaner. In one or more arrangements, the cleaner may be an auger cleaner.

In one or more arrangements, the cleaning system includes a box system the box having an interior volume. In one or more arrangements, the box system is configured to operably connect to the closed system and the cleaner is initially positioned at least partially within the interior volume of the box system.

In one or more arrangements, the cleaning system includes a gate complex. In one or more arrangements, the gate complex is configured to allow selective access into the closed system and the gate complex is located below the surface level created by the liquid within the closed system. In one or more arrangements, the gate complex includes a gate configured to be selectively moved between an open position and a closed position, and when the gate is in the open position, the cleaner is configured to enter the closed system.

In one or more arrangements, includes the box system and the gate complex with the gate. In one or more arrangements, when the gate is in the open position, the liquid from within the closed system flows into the interior volume of the box system and is contained therein.

### BRIEF DESCRIPTION OF THE FIGURES

FIG. 1 is a top down view of a representation of an auger cleaned inaccessible floor system.

FIG. 2 is a top down view of a representation of a box of the auger cleaned inaccessible floor system.

FIG. 3 is a representation of a gate complex of the auger cleaned inaccessible floor system.

FIG. 4 is a representation of a sump pump of the auger cleaned inaccessible floor system.

FIG. 5 is a representation of a slope of an inaccessible floor having a circular shape, where the inaccessible floor is inaccessible due to submersion under liquid.

FIG. 6 is a slope of an inaccessible floor having a rectangular shape, where the inaccessible floor is inaccessible due to submersion under liquid.

FIG. 7 is a slope of an inaccessible floor having a rectangular shape, where the inaccessible floor is inaccessible due to livestock.

FIG. 8 is a slope of an inaccessible floor having a rectangular shape, where the inaccessible floor is inaccessible due to livestock.

FIG. 9 represents an auger cleaner.

FIG. 10a. represents a boom in a retracted position.

FIG. 10b. represents the boom in an extended position.

FIG. 11 represents a hydraulic system of the auger cleaned inaccessible floor system.

FIG. 12a. represents a method for cleaning the auger cleaned inaccessible floor system.

FIG. 12b. is a pictorial representation of the method of FIG. 12a.

FIG. 13 is a perspective view of a retrofit box system in connection with an inaccessible floor system.

FIG. 14A is a side view of a box of the retrofit box system.

FIG. 14B is a transparent perspective view of the retrofit box system.

FIG. 15 represents a gate complex of the retrofit box system.

FIG. 16 represents the cleaner of the retrofit box system.

FIG. 17 represents the power system of the retrofit box system.

FIG. 18 represents the control system of the retrofit box system.

FIG. 19A represents a first perspective view of the transfer carriage of the retrofit box system.

FIG. 19B represents a second perspective view of the transfer carriage of the retrofit box system.

FIG. 19C represents a side view of the transfer carriage of the retrofit box system.

FIG. 19D represents a top view of the transfer carriage with a carriage retracted.

FIG. 19E represents a top view of the transfer carriage with the carriage extended.

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of the anaerobic digester tanks or lagoons. However, the embodiments are not so limited. It is appreciated that the embodiments may be adapted for use in other applications which may be improved by the disclosed structures, arrangements and/or methods. The system is merely shown and described as being used in the context of anaerobic digester tanks or lagoons for ease of description and as one of countless examples.

### Anaerobic Digester Tank or Lagoon

The cleaning system presented herein is configured to be used in an enclosed space, including as examples, an anaerobic digester tank or lagoon. The cleaning system may be installed on an anaerobic digester tank or lagoon during construction of the tank or lagoon, or the cleaning system may be retrofit to an existing anaerobic digester tank or lagoon. In one or more arrangements, as examples, the anaerobic digester tank or lagoon to which the cleaning system is connected will have a gate complex. In one or more arrangements, the cleaning system is connected to the gate complex and the gate complex provides fluid communication between the inside of the anaerobic digester tank or lagoon and the cleaning system. In this way, the cleaning system can deliver a cleaning device into the anaerobic digester tank or lagoon in order to clean the inaccessible floor of the anaerobic digester tank or lagoon.

### Cleaning System

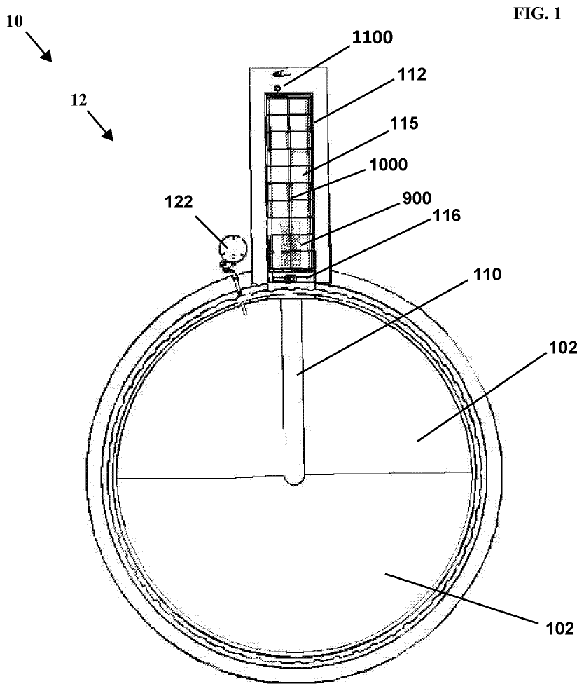

In one or more arrangements, a cleaning system 10 for cleaning a floor of a closed system is presented. In the arrangement shown in FIGS. 1-12B, a cleaning system 10 is presented. The cleaning system 10 presented in FIGS. 1-12B may be the auger cleaned inaccessible floor system 12 presented in U.S. patent application Ser. No. 17/648,636, U.S. patent application Ser. No. 16/783,629 (now U.S. Pat. No. 11,298,731), and/or U.S. Provisional Application No. 62/805,785, which are hereby incorporated by reference herein in their entireties.

In one or more arrangements, an auger cleaned inaccessible floor system 12 to maximize operational capacity of inaccessible floors is described. The auger cleaned inaccessible floor system 12 includes a floor having at least one channel beneath the lowest point of the floor extending horizontally at least half the length of the longest dimension of the floor and adapted for receiving an auger cleaner, at least one gate complex that provides fluid communication between the channel and at least one box and further provides access to the floor for the auger cleaner, and at least one box to deliver the auger cleaner to the channel and adapted for equalizing pressure when the inaccessible floor is under water to deliver an auger cleaner for cleaning. The auger cleaned inaccessible floor system 12 may include a sump pump to remove waste from the at least one box and may deliver liquid back to the inaccessible floor system when the floor is submerged. As used herein waste, for example from anaerobic digestion and livestock, is considered fluid.

The auger cleaner is delivered to the channel of the inaccessible floor via the at least one gate complex and a multi-segmented horizontal boom that provides horizontal extension for longitudinal movement of the auger cleaner in the channel. Thus, the auger cleaned inaccessible floor system 12 allows cleaning of the inaccessible floor while the inaccessible floor system is in operation increasing the yield from the inaccessible floor system. Further, the inaccessible floor system does not require a human to enter the inaccessible floor decreasing risk associated with cleaning.

FIG. 1 represents a top down view of an auger cleaned inaccessible floor system 12. The auger cleaned inaccessible floor system 12 includes a floor 102, at least one gate complex 116, at least one box 112, an auger cleaner 900, a boom 1000, and a hydraulic system 1100. The floor 102 may be submerged under liquid, may be underneath a mechanical barrier, or may contain livestock, such that the floor 102 is inaccessible during use. The auger cleaned inaccessible floor system 12 may include a sump pump 122 when the floor 102 is submerged.

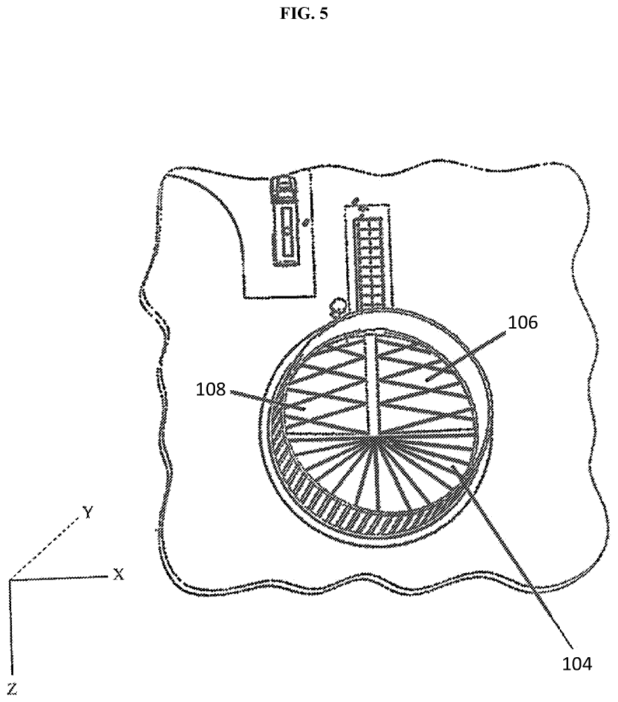

The floor 102 is sloped toward at least one channel 110 to efficiently deliver waste to the channel 110 (see FIGS. 5-8). The floor 102 may be of any shape compatible with waste accumulation, such as circular, rectangular, or square. The floor 102 may be made of any non-corrosive material, such as stainless steel, concrete, or metal alloys. The material of the floor 102 may further be covered with a non-corrosive material, such as corrosion resistant polymers or powders to increase the ability of waste to move to the at least one channel 110 efficiently.

The at least channel 110 of the digester floor 102 receives waste. The channel 110 is in fluid communication with the floor 102. The at least one channel 110 further receives an auger cleaner 900. The at least one channel 110 extends horizontally from the gate 119 for at least half the length of the longest dimension of the floor 102. The at least one channel 110 is below the lowest point of the floor 102, such as from 4 to 12 inches deep. Preferably the at least one channel 110 is from 6 to 10 inches deep. Most preferably the at least one channel 110 is from 7 to 9 inches deep.

The width of the at least one channel 110 is adapted to receive the auger cleaner 900 for longitudinal movement along the channel 110, such as from 2 to 6 feet wide. Preferably the channel 110 is from 3 to 5 feet wide. Most preferably the channel 110 is from 3.5 to 4.5 feet wide. The channel 110 increases the surface area and volume for waste to accumulate in the auger cleaned inaccessible floor system 12.

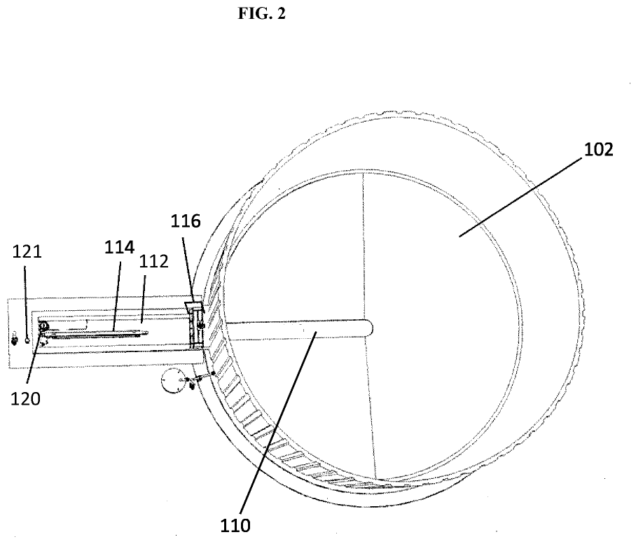

The at least one box 112 of the auger cleaned inaccessible floor system 12 is in fluid communication with the at least one channel 110 and delivers the auger cleaner 900 to the at least one channel 110. The box 112 having a box interior volume may further equalize liquid pressure in the auger cleaned inaccessible floor system 12 for delivery of the auger cleaner 900 to the channel 110, when the floor 102 is submerged. The at least one box 112 is from 15 to 30 feet in length, 3 to 7 feet in width, and 3 to 7 feet in height. The at least one box 112 includes a lid 115, a rail 114 (see FIG. 2), a waste discharge pipe 121 (see FIG. 2), and hydraulic disconnects 120 (see FIG. 2).

The lid 115 (shown as transparent in FIG. 1 for illustration purposes) of the at least one box 112 seals the at least one box 112 during use of the auger cleaner 900. When the floor 102 is submerged under liquid, the at least one box 112 allows liquid to enter the box interior volume to equalize fluid pressure of the auger cleaned inaccessible floor system 12, where the liquid remains in the auger cleaned inaccessible floor system 12 during cleaning as the lid 115 seals the box 112. The lid 115 is substantially the same length and width as the box 112. The lid 115 is removably attached to the box 112 to seal the box 112, such as through bolts, screws, or combinations thereof. The lid 115 may be made of a non-corrosive material such as stainless steel, metal alloys, or the like.

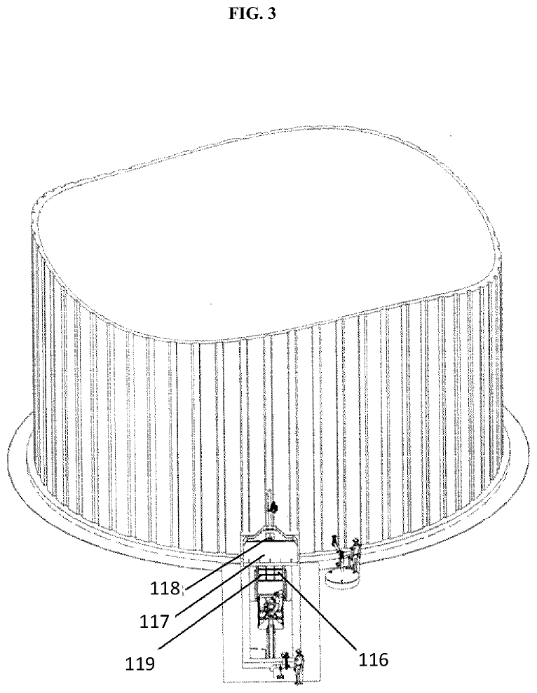

The at least one gate complex 116 of the auger cleaned inaccessible floor system 12 is configured to provide the auger cleaner 900 with access to the at least one channel 110 of the floor 102, as shown in FIG. 3.

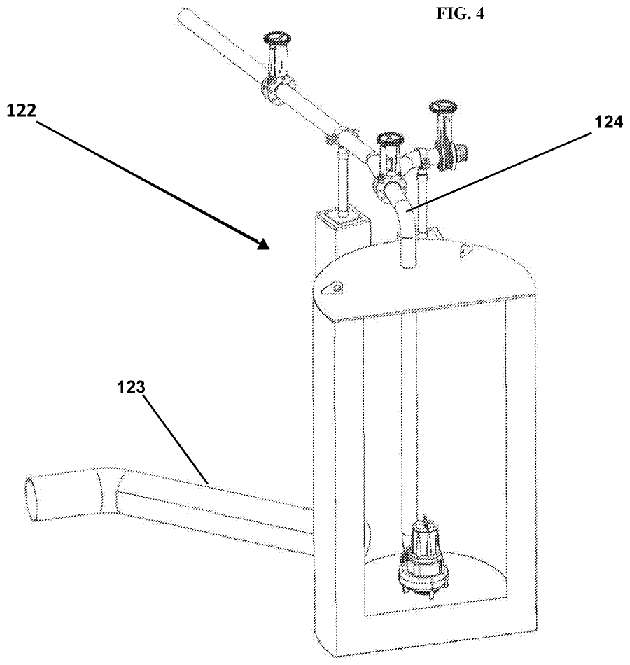

The sump pump 122 of the auger cleaned inaccessible floor system 12 removes liquid digestate and water from the at least one box 112 after cleaning, as further described in FIG. 4.

FIG. 2 represents the at least one box 112 of the auger cleaned inaccessible floor system 12 without the auger cleaner 900. The rail 114 of the at least one box 112 is attached in the box interior volume. The rail 114 provides removable attachment for the boom 1000 to fix the boom 1000, providing push points during extension and retraction of the boom 1000. The rail 114 may be an I-beam. The rail 114 may be made of any non-reactive material, such as stainless steel, metal alloys, or the like.

The waste discharge pipe 121 provides fluid communication with the boom 1000 to dispose of waste from the auger cleaned inaccessible floor system 12. The waste discharge pipe 121 may include a valve to control flow of the waste, such as to a waste removal truck for disposal of the waste. The hydraulic disconnects 120 of the box 112 provide hydraulic communication between the auger cleaner 900, the boom 1000, and the hydraulic system 1100.

FIG. 3 represents the at least one gate complex 116. The at least one gate complex 116 separates the at least one box 112 from the floor 102. The at least one gate complex 116 includes a gate 119, a gate shield 117, and gate controller 118. The gate 119 of the at least one gate complex 116 separates the at least one channel 110 of the floor 102 from the at least one box 112 hindering fluid communication when in a closed position. When in an open position (as shown), the at least one gate 119 allows fluid communication between the channel 110 and the box interior volume of the box 112, and provides access to the at least one channel 110 for the auger cleaner 900. The gate controller 118 opens and closes the gate 119, such as via a single cylinder hydraulic drive motor, an electric motor, or a manual hydraulic control. The at least one gate complex 116 may include a gate shield 117 that substantially receives the gate 119 when it is open to protect it from damage. The gate shield 117 may be of any non-corrosive material such as stainless steel, metal alloys, or the like.

FIG. 4 represents the sump pump 122 of the auger cleaned inaccessible floor system 12. The sump pump 122 is configured to remove water from the at least one box 112 upon completion of cleaning the auger cleaned inaccessible floor system 12. The sump pump 122 is located substantially underground adjacent to the auger cleaned inaccessible floor system 12 and the at least one box 112. The sump pump 122 includes a drain 123, and a discharge line 124. The sump pump 122 is in fluid communication with the box 112 via a drain 123. The sump pump 122 delivers water from the box 112 to a water truck for disposal or back to the auger cleaned inaccessible floor system 12 via a discharge line 124.

FIG. 5 represents the slope of the floor 102 when the floor 102 is circular in shape and is submerged under liquid, such as in an anaerobic digestion tank. For example, the floor 102 may include a sloped segment 104, a first sloped quadrant 106, and a second sloped quadrant 108. The sloped segment 104 of the floor 102 is sloped to deliver waste to the at least one channel 110 distal to the at least one gate 119. The first sloped quadrant 106 is sloped to deliver waste to the at least one channel 110 proximal to the at least one gate 119. The second sloped quadrant 108 is sloped to deliver digestate to the at least one channel 110 proximal to the at least one gate 119.

The slope of the sloped segment 104 is represented by the solid black lines in the sloped segment 104 to demonstrate that the sloped segment 104 is sloped in a conical manner toward the at least one channel 110 to deliver waste to the at least one channel 110 distal to the at least one gate 119. The sloped segment 104 has a slope from 8 to 12 percent (length to height). Preferably the sloped segment 104 has a slope from 9 to 11 percent, and most preferably the sloped segment 104 has a slope of 10 percent.

The slope of the first sloped quadrant 106 is represented by the solid lines in the first sloped quadrant 106 to demonstrate that the first sloped quadrant 106 is sloped in two dimensions along the x axis and the y axis. The slope is downward both toward the at least one channel 110 and the at least one gate 119, where the lowest point of the first sloped quadrant 106 is the point nearest to the at least one gate 119. The slope of the first sloped quadrant 106 is equal to the slope of the sloped segment 104, along the line where the first sloped quadrant 106 meets the sloped segment 104. The first sloped quadrant 106 has a slope from 8 to 12 percent (length to height). Preferably the first sloped quadrant 106 has a slope from 9 to 11 percent, and most preferably the first sloped quadrant 106 has a slope of 10 percent.

The slope of the second sloped quadrant 108 is represented by the solid lines in the second sloped quadrant 108 to demonstrate that the second sloped quadrant 108 is sloped in two dimensions along the x axis and the y axis. The slope is both toward the at least one channel 110 and the at least one gate 119, where the lowest point of the second sloped quadrant 108 is the point nearest to the at least one gate 119. The slope of the second sloped quadrant 108 is equal to the slope of the sloped segment 104, along the line where the second sloped quadrant 108 meets the sloped segment 104. The second sloped quadrant 108 has a slope from 8 to 12 percent (length to height). Preferably the second sloped quadrant 108 has a slope from 9 to 11 percent, and most preferably the second sloped quadrant 108 has a slope of 10 percent. The sloped segment 104, the first sloped quadrant 106, and the second sloped quadrant 108 may be formed as a single unit, such as through poured concrete.

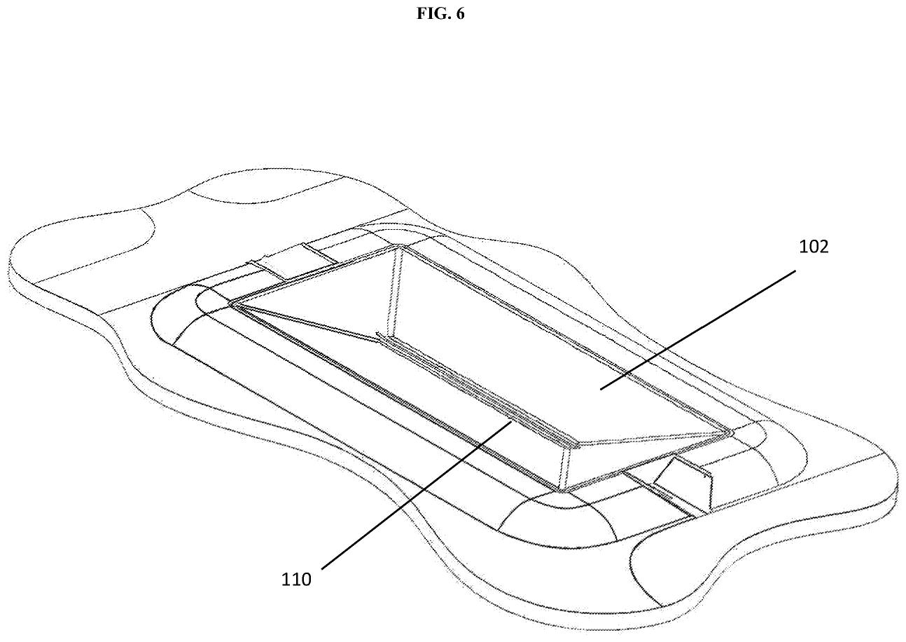

FIG. 6 represents the slope of the floor 102 when the floor 102 is rectangular in shape and is submerged under liquid, such as in an anaerobic lagoon. For example, the floor 102 is sloped toward the at least one channel 110 that extends the length of the floor 102. When the length of the channel 110 extends the length of the floor 102, the auger cleaned inaccessible floor system 12 may include two gate complexes 116 and two boxes 112 to access the channel 110 from either end of the channel 110.

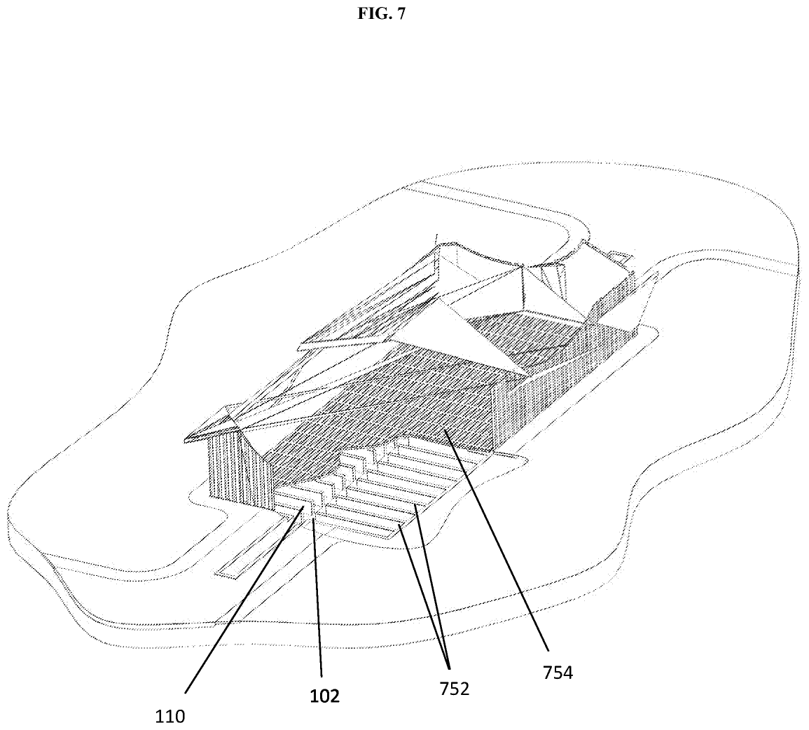

FIG. 7 represents the slope of the floor 102 when the floor 102 is rectangular in shape and is inaccessible due to a mechanical barrier, such as in a hog barn. For example, the floor 102 is sloped toward the at least one channel 110 that extends the length of the floor 102. The floor 102 further includes a plurality of slats 752 and a false floor 754. The slats 752 extend vertically from the floor 102 to the false floor 754 and are spaced along the floor 102 to direct waste evenly to the at least one channel 110. The false floor 754 substantially covers the floor 102 and rests upon the slats 752. The false floor 754 includes a plurality of slits to allow waste to pass through the false floor 754 to the floor 102 and the at least one channel 110.

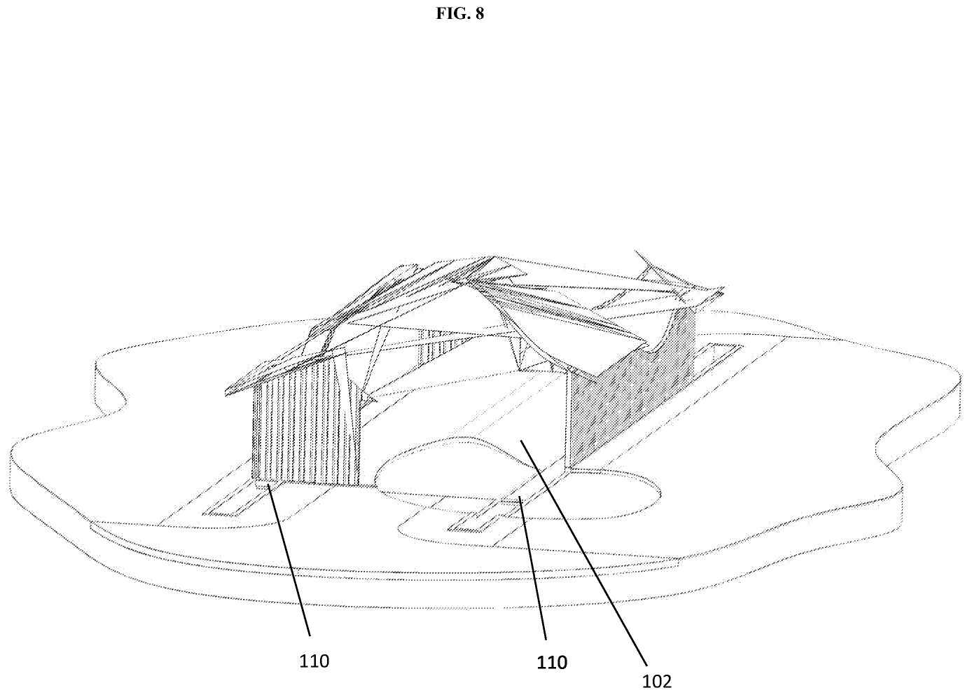

FIG. 8 represents the slope of the floor 102 when the floor 102 is rectangular in shape and contains livestock during use, such as in a dairy barn. The floor 102 may include two channels 110, where the floor 102 is sloped substantially from the center of the floor 102 downward to the respective channel 110. FIG. 8 includes a representation of a cut-away to demonstrate the slope of the floor 102.

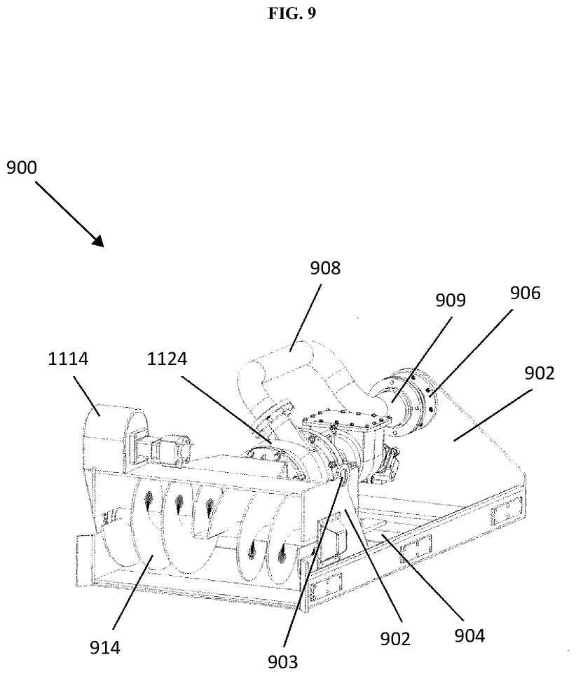

FIG. 9 represents an auger cleaner 900 adapted for longitudinal movement in the channel 110 for removal of waste from the floor 102. The auger cleaner 900 includes a frame 902, a waste pipe 908, a flex connection 909, an auger 914, an auger drive 1114, and an eddy sludge pump 1124. The auger cleaner 900 is in hydraulic communication with a hydraulic system 1100 for operation of the auger drive 1114 and the eddy sludge pump 1124. The auger cleaner 900 is further in fluid communication with a boom 1000 for transfer of waste for disposal.

The frame 902 is substantially the width of the channel 110, such as from 80 to 100 inches long, 40 to 60 inches wide, and from 30 to 40 inches tall. A portion of the frame 902 partially surrounds the auger 914 to increase the efficiency of waste collection by the auger 914. The frame 902 may be made of any non-corrosive material, such as stainless steel, or metal alloys.

The frame 902 may include one or more skid plates 904. The one or more skid plates 904 allow the auger cleaner 900 to move along the floor 102. The frame 902 may further include one or more boom attachments 906 for removable attachment of the auger cleaner 900 to the boom 1000. The one or more boom attachments 906 may be bolts, screws, or the like. The frame 902 may include transport attachment points 903 configured to allow for transport (lifting) of the auger cleaner 900 into and out of the box 112 prior to and after cleaning of the floor 102.

The waste pipe 908 of the auger cleaner 900 transports waste from the eddy sludge pump 1124 to the boom 1000 via the flex connection 909. The waste pipe 908 is in fluid communication with a hydraulic sludge pump and the flex connection 909. The waste pipe 908 may be made of any non-corrosive material, such as stainless steel or metal alloys. The waste pipe 908 may have a diameter from 3 to 5 inches.

The flex connection 909 provides flexible attachment of the auger cleaner 900 to the boom 1000. The flex connection 909 allows vertical and horizontal movement of the auger cleaner 900 during cleaning due to encountering irregularities (e.g. waste in the channel 110) without applying undue torque on the boom attachments 906.

The auger 914 of the auger cleaner 900 disturbs waste on the floor 102 by spinning perpendicular to the width of the channel transporting the waste toward the center of the auger 914, where the eddy sludge pump 1124 pumps the waste to the waste pipe 908. The auger 914 is in mechanical communication with the frame 902 and is in hydraulic communication with the auger drive 1114 of the hydraulic system 1100. The auger 914 is substantially the width of the frame 902. The auger 914 is from 12 to 24 inches in height. The auger 914 is made of a non-corrosive material, such as stainless steel, or metal alloys.

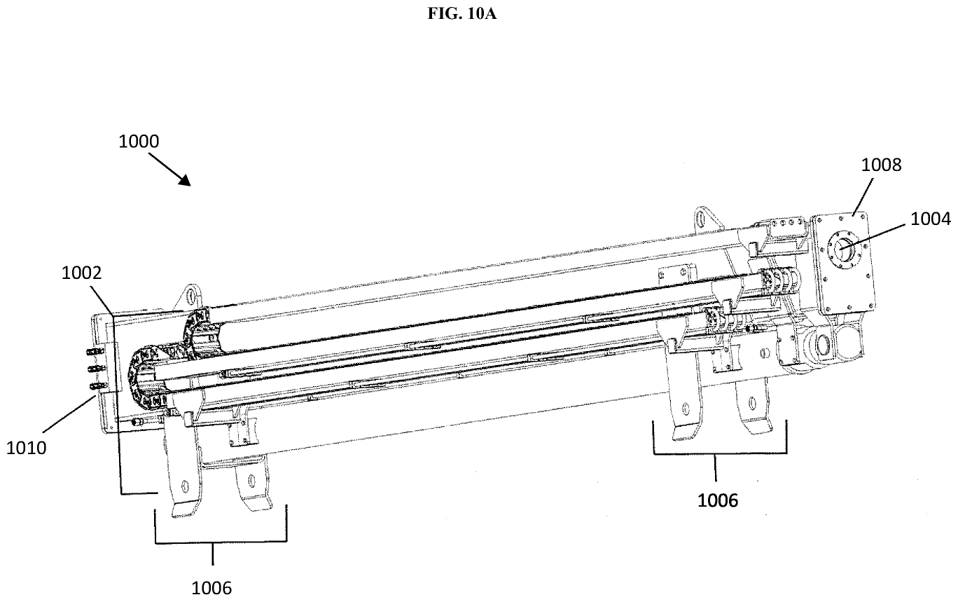

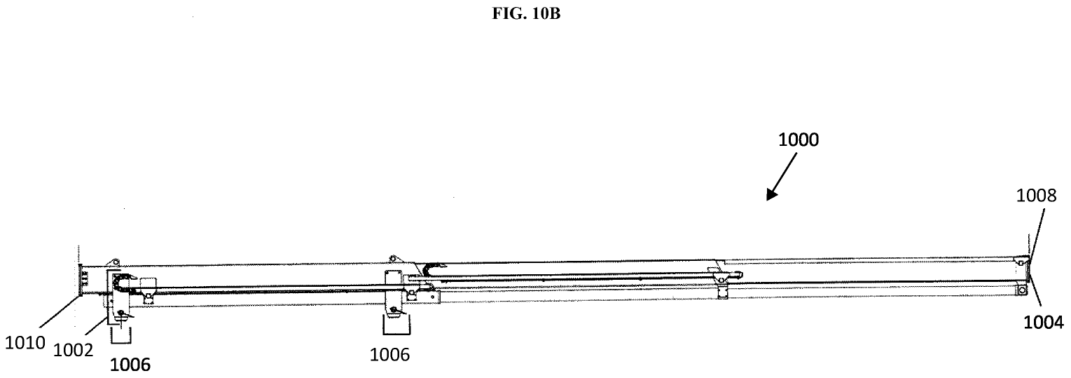

FIG. 10a represents a multi-segmented boom 1000 in a retracted position. The boom 1000 provides longitudinal extension and retraction of the auger cleaner 900 within the channel 110 and provides for transfer of waste from the auger cleaner 900 for final disposal away from the auger cleaned inaccessible floor system 12. The boom 1000 includes a boom extender 1002, a waste transfer component 1004, a rail attachment 1006, an auger cleaner attachment 1008, and a waste removal attachment 1010. The boom extender 1002 is multi-segmented and extends and retracts the boom 1000. The boom extender 1002 is in hydraulic communication with the hydraulic system 1100. The waste transfer component 1004 is multi-segmented and is in fluid communication with the auger cleaner 900 for transfer of waste for disposal. In the retracted position the multi-segments of the boom extender 1002 and waster transfer component 1004 are compact.

The rail attachment 1006 of the boom 1000 provides removable attachment of the boom 1000 to the rail 114 of the box 112, such as through bolts, screws, or the like. The auger cleaner attachment 1008 provides removable attachment of the boom 1000 to the auger cleaner 900, such as through bolts, screws, or the like. The waste removal attachment 1010 provides removable attachment of the boom 1000 to the waste discharge pipe 121 and provides fluid communication of the waste transfer component 1004 to the waste discharge pipe 121 for final transfer and disposal of waste away from the auger cleaned inaccessible floor, such as to a truck equipped to transfer the waste.

FIG. 10b represents the boom in an extended position. In the extended position the multi-segments of the boom extender 1002 and the waste removal component 1004 are extended.

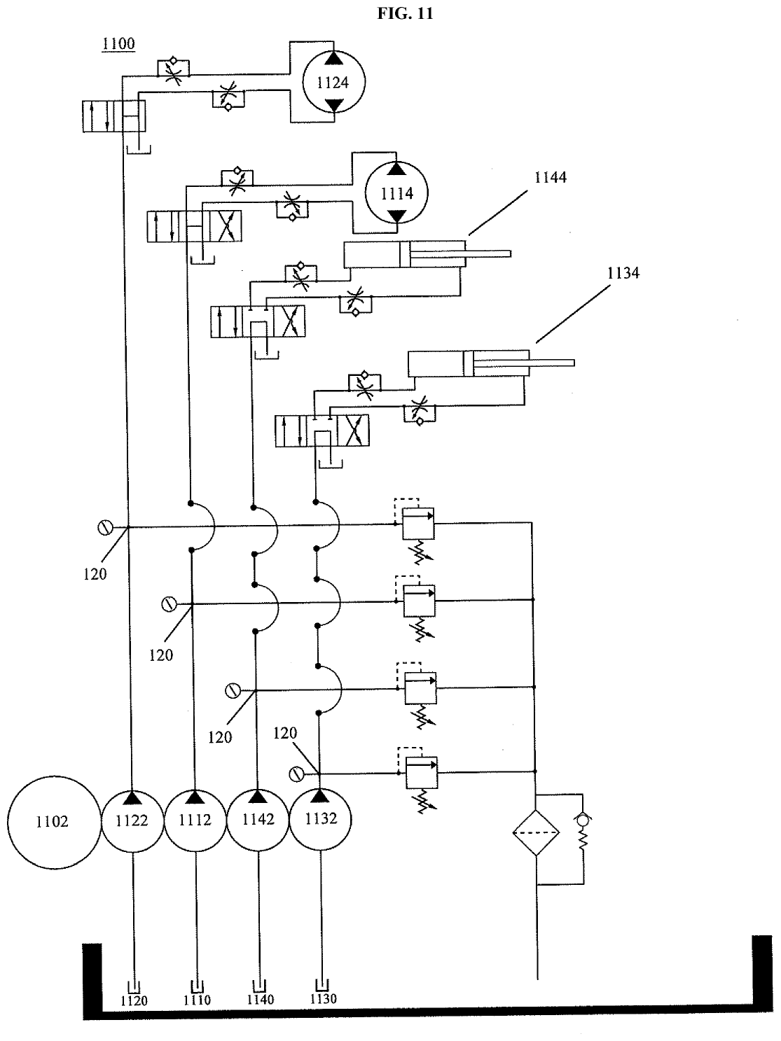

FIG. 11 represents the hydraulic system 1100 of the auger cleaned inaccessible floor system 12. The hydraulic system 1100 powers the auger cleaner 900 to remove waste from the floor 102 and powers the boom to extend and retract the auger cleaner 900. The hydraulic system 1100 includes an auger circuit 1110, a pump hydraulic circuit 1120, a boom circuit 1130, and a winch circuit 1140.

The auger circuit 1110 is configured to power the auger cleaner 900. The auger circuit 1110 includes a motor 1102, an auger pump 1112, and an auger drive 1114. The motor 1102, the auger pump 1112 and the auger drive 1114 are in fluid communication, where the motor 1102 delivers power to the auger pump 1112, and the auger pump 1112 provides hydraulic power to the auger drive 1114. The auger drive 1114 powers (spins) the auger 914 of the auger cleaner 900. The auger drive 1114 may be low speed (up to 310 revolutions per minute), high torque hydraulic drive (up to 1700 pounds/inch), such as an Eaton 6000 series motor with displacement of 735 cubic centimeters per revolution.

The pump hydraulic circuit 1120 of the hydraulic system 1100 is configured to power the eddy sludge pump 1124. The pump hydraulic circuit 1120 includes the motor 1102, a sludge pump 1122, and the eddy sludge pump 1124. The motor 1102, the sludge pump 1122, and the eddy sludge pump 1124 are in fluid communication. The motor 1102 powers the sludge pump 1122 to provide hydraulic power to the eddy sludge pump 1124. The eddy sludge pump 1124 pumps waste from the auger 914 through the waste line 908 and the waste transfer component 1004 for disposal of the waste. The eddy sludge pump 1124 is adapted for pumping waste with a high concentration of solids to liquid (40% to 70%) and is adapted for operation in both submerged and atmospheric conditions. The eddy sludge pump 1124 has a flow rate from 250 to 1200 gallons per minute, a suction size of 6 inches, a discharge size of 4 inches, and has a maximum speed of 1800 revolutions per minutes, such as a 4 inch HD 4000 Eddy Pump.

The boom circuit 1130 of the hydraulic system 1100 is configured to extend and retract the boom 1000. The boom circuit includes the motor 1102, a boom pump 1132, and a boom cylinder 1134. The motor 1102, the boom pump 1132, and the boom cylinder 1134 are in fluid communication. The motor 1102 powers the boom pump 1132 to deliver hydraulic power to the boom cylinder 1134. The boom cylinder 1134 is a double acting cylinder to extend the boom 1000 to the extended position and retract the boom 1000 to the retracted position.

The hydraulic system 1100 may contain a winch circuit 1140 configured to retract the boom 1000 in the event of a failure of the boom circuit 1130. The winch circuit 1140 includes the motor 1102, a winch pump 1142, and a winch 1144. The motor 1102, the winch pump 1142, and the winch 1144 are in fluid communication. The motor 1102 powers the winch pump 1142 to deliver hydraulic power to the winch 1144. The winch 1144 has pulling capacity of up to 25,000 pounds and retracts the boom 1000 in the case of a failure of the boom circuit 1130.

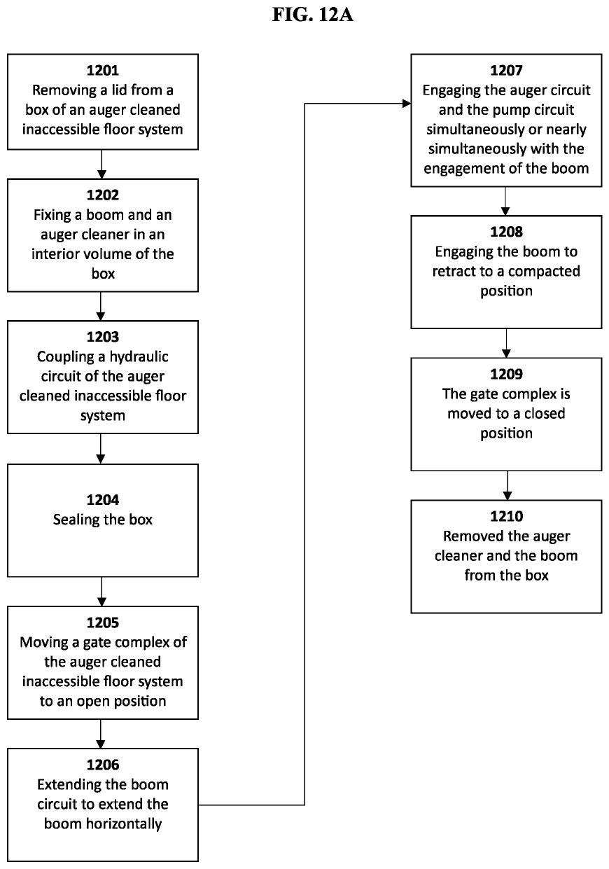

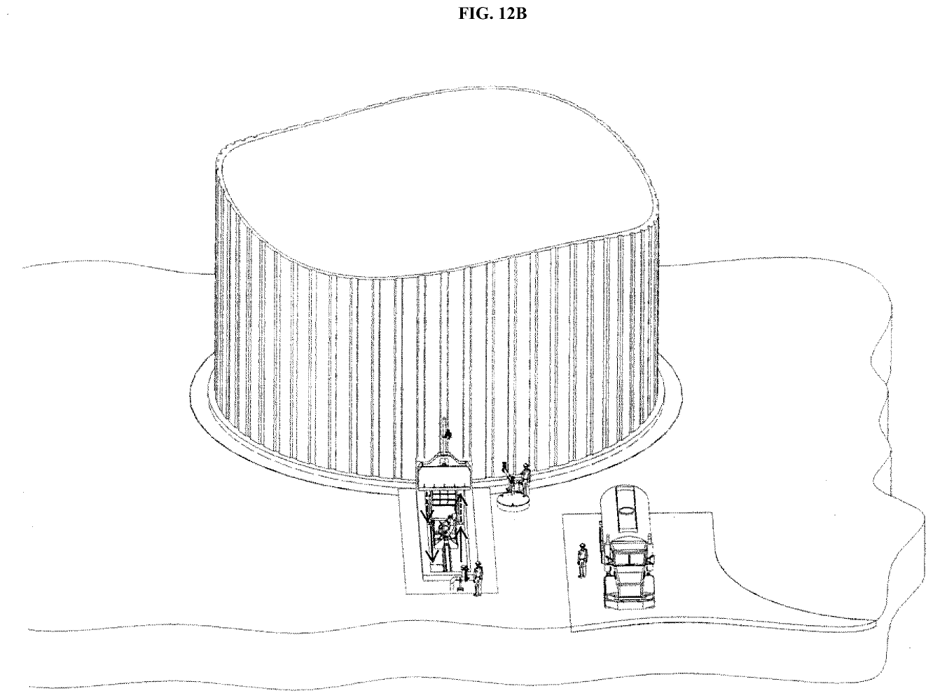

FIG. 12a. represents a method of cleaning the auger cleaned inaccessible floor system 12. In 1201, the lid 115 of the box 112 is removed. In 1202, the boom 1000 and the auger cleaner 900 are fixed in the interior volume of the box 112. The fixing includes removably attaching the boom 1000 to the rail 114. The boom is further removably attached to the waste discharge pipe 121 via the waste removal attachment 1010. The fixing further includes, placing the auger cleaner 900 in the box 112 and removably attaching the auger cleaner 900 to the boom 1000 via the boom attachments 906 and the auger cleaner attachment 1008. The fixing further includes removably connecting the winch 1144 to the auger cleaner 900.

In 1203, the hydraulic system 1100 that includes the auger circuit 1110, the pump circuit 1120, the boom circuit 1130, and the winch circuit 1140 is coupled. The hydraulic disconnects 120 couple the auger drive 1114, the eddy sludge pump 1124, the winch 1144, and the boom cylinder 1134 to the motor 1102, the auger pump 1112, the sludge pump 1122, the boom pump 1132, and the winch pump 1142, respectively. The motor 1102, the auger pump 1112, the sludge pump 1122, the boom pump 1132, and the winch pump 1142 may be on a truck for transport to and from the auger cleaned inaccessible floor system 12.

In 1204 the box 112 is sealed by removably attaching the lid 115 to the box 112. In 1205, the gate complex 116 is moved to an open position by engaging the gate controller 118. Once the gate complex 116 is in the open position, the box 112 may fill with liquid when the floor 102 is submerged and pressure inside the auger cleaned inaccessible floor system 12 will equalize.

In 1206, the boom circuit 1130 is engaged to extend horizontally, where the auger cleaner 900 moves longitudinally in the channel 110. In 1207, simultaneously or nearly simultaneously with 1206, the auger cleaner 900 is engaged; where the auger 914 and eddy sludge pump 1124 are engaged to remove waste from the channel 110 of the floor 102. Waste travels from the eddy sludge pump 1124 to the waste pipe 908, to the flex connection 909, to the waste transfer component 1004 of the boom 1000, to the waste discharge pipe 121 for final disposal away from the auger cleaned inaccessible floor system 12.

In 1208, the boom circuit 1130 is engaged to retract to the retracted position, where the auger cleaner 900 is retracted longitudinally in the channel 110 back into the box 112. In 1209, the gate complex 116 is moved to a closed position by engaging the gate controller 118.

In 1210, the auger cleaner 900 and boom 1000 are removed from the box 112. When the floor is submerged the removal of the auger cleaner 900 and boom 1000 may further include engaging the sump pump 122 to remove liquid from the box 112. Removing the auger cleaner 900 and the boom 1000 includes removing lid 115, and disconnecting the hydraulic system 1100 via the hydraulic disconnects 120. Finally, the auger cleaner 900 and boom 1000 are removed from the box 112, and the lid 115 is removable fixed to the box 112.

FIG. 12b. is a pictorial representation of the method 1200 to illustrate the steps 1205, 1206, 1207, 1208, and 1209. The lid 115 is shown in a transparent manner for illustration purposes.

### Alternative Arrangement:

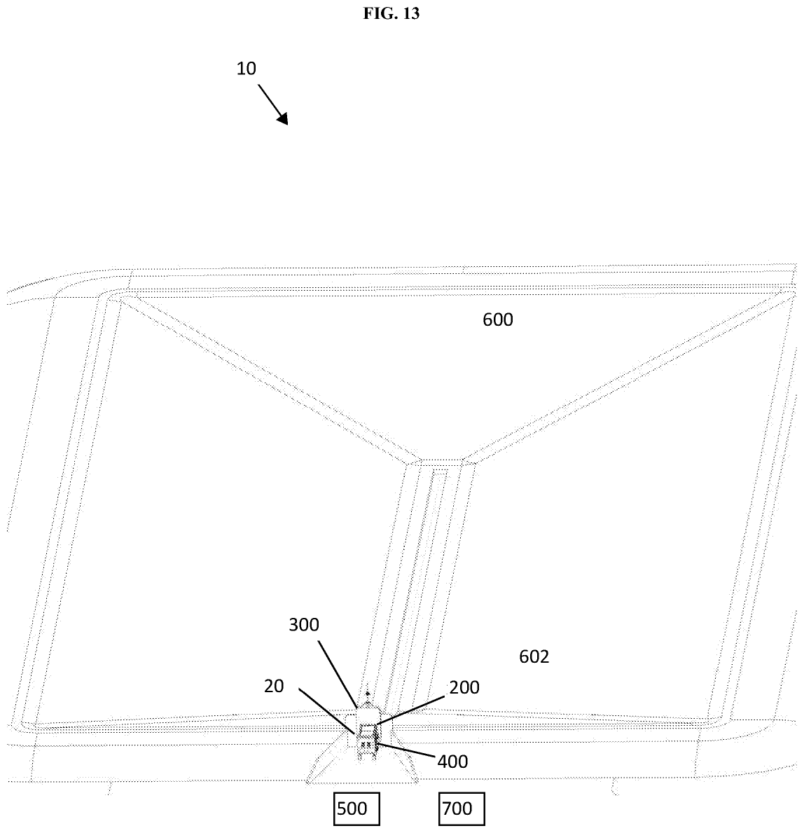

In one or more alternative arrangements, a cleaning system 10 for cleaning a floor of a closed system is presented. In the arrangement shown in FIGS. 13-19E, a cleaning system 10 is presented. The cleaning system 10 presented in FIGS. 13-19E may be the retrofit box system 20 from U.S. patent application Ser. No. 17/982,656, U.S. patent application Ser. No. 16/868,140 (now U.S. Pat. No. 11,534,045), and/or U.S. Provisional Application No. 62/843,897, which are hereby incorporated by reference herein in their entireties.

In one or more arrangements, a retrofit box system 20 to maximize operational capacity of inaccessible floors is described. The retrofit box system 20 includes a gate complex that provides fluid communication between an inaccessible floor and a box, and a box to deliver a cleaner to the inaccessible floor and adapted for equalizing pressure when the inaccessible floor is under water while minimizing waste seepage from the retrofit box system 20. The retrofit box system 20 further includes a power system and a control system to deliver the cleaner to the inaccessible floor and remove waste from the inaccessible floor and the box. As used herein waste, for example from anaerobic digestion, is considered fluid.

The cleaner is delivered to the inaccessible floor via the at least one gate complex and the power system and control system that provide wireless controlled movement of the cleaner throughout the floor system. Thus, the retrofit box system 20 allows cleaning of the inaccessible floor while the inaccessible floor system is in operation increasing the yield from the inaccessible floor system. Further, the retrofit box system 20 does not require a human to enter the inaccessible floor decreasing risk associated with cleaning.

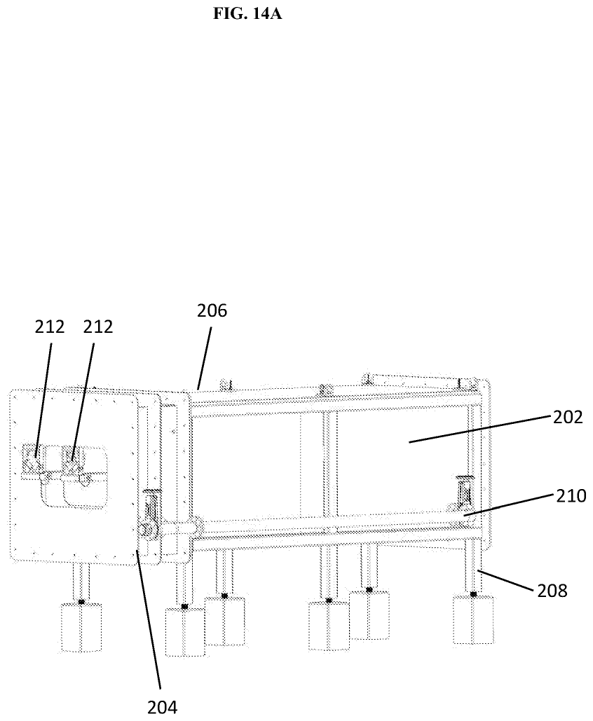

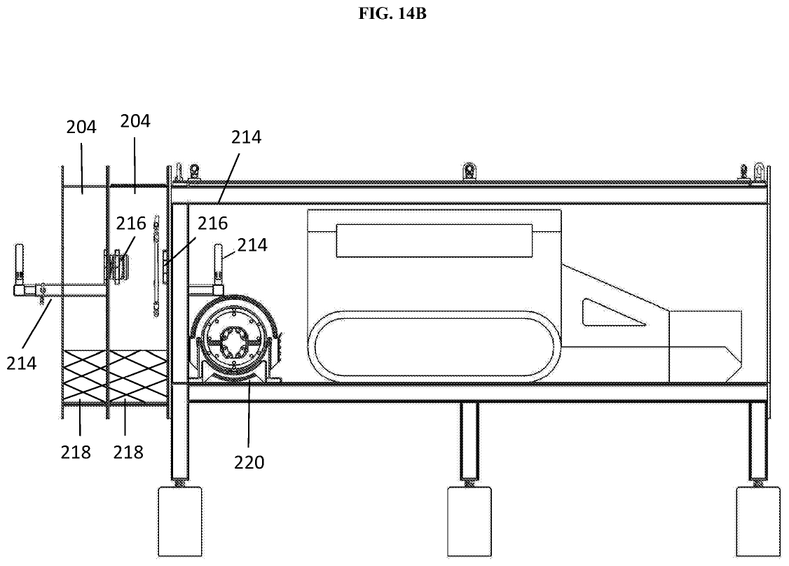

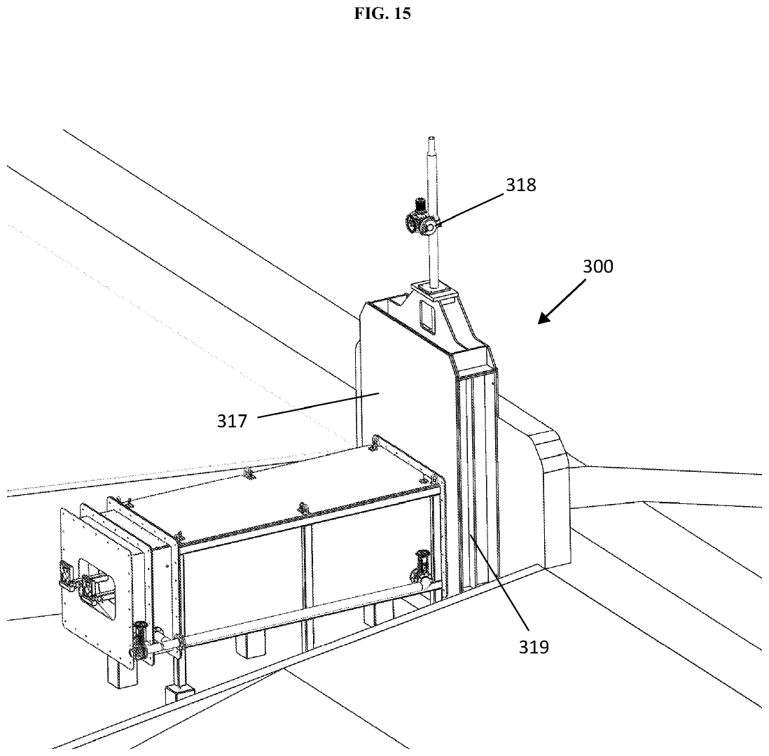

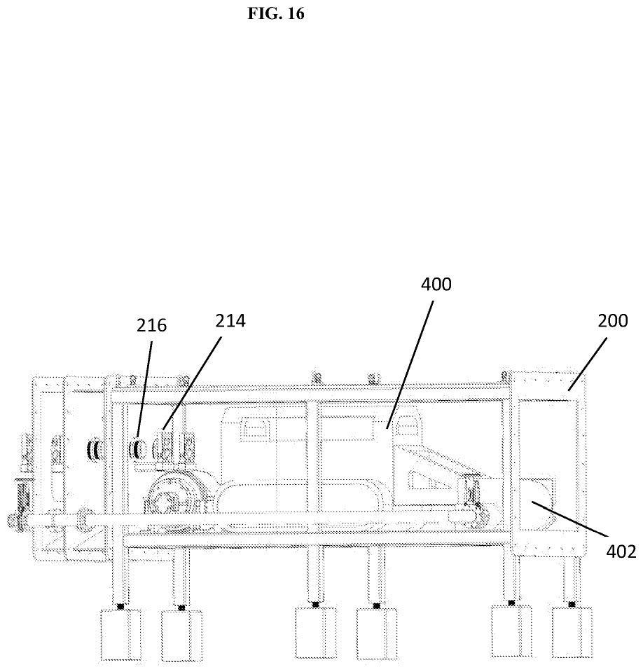

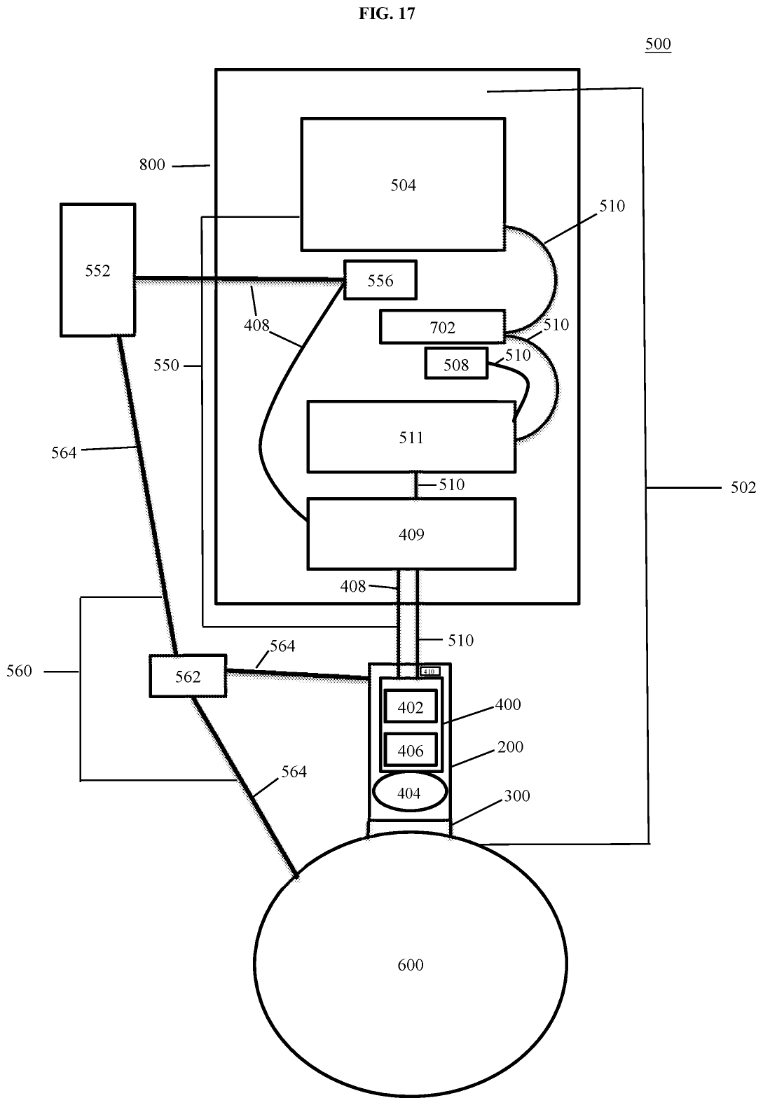

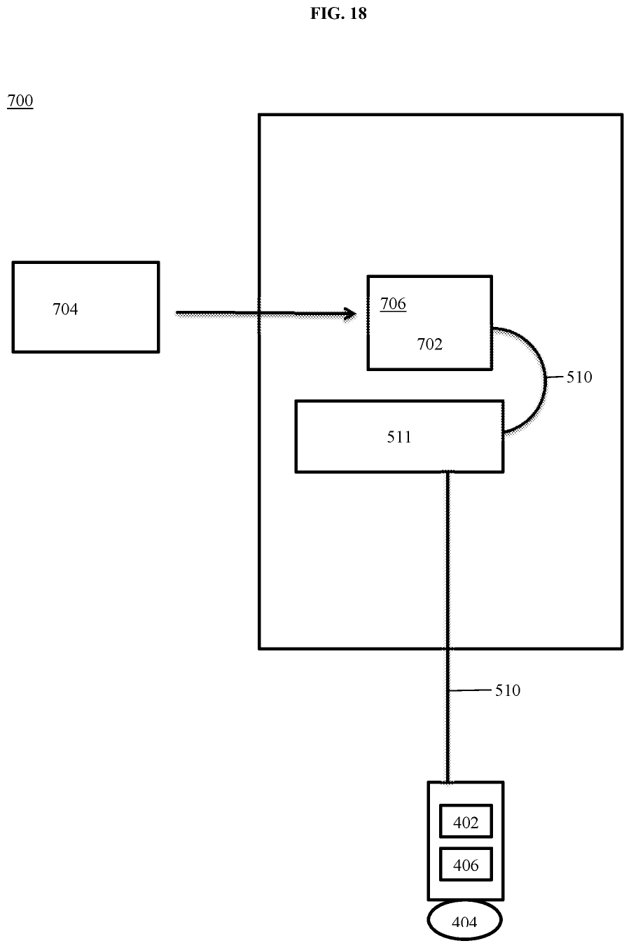

FIG. 15 is a perspective view of a retrofit box system 20 in connection with an inaccessible floor system 600. The retrofit box system 20 includes a box 200 (see FIGS. 14A and 14B), at least one gate complex 300 (see FIG. 15), a cleaner 400 (see FIG. 16) and a power system 500 (see FIG. 17), and a control system 700 (see FIG. 18). The inaccessible floor system 600 includes an inaccessible floor 602. The inaccessible floor 602 may be submerged under liquid, such that the inaccessible floor 602 is inaccessible during use. For example, the inaccessible floor system 600 may be an anaerobic digester tank or an anaerobic lagoon.

The box 200 of the retrofit box system 20 is in fluid communication with the inaccessible floor 602 via the gate complex 300 and allows delivery of the cleaner 400 to the inaccessible floor 602. The box 200 having a box interior volume (i.e. a deployment chamber interior volume and at least one wash chamber interior volume(s)) may further equalize liquid pressure between the box 200 and the inaccessible floor system 600 for delivery of the cleaner 400 to the inaccessible floor 602 while minimizing seepage from the retrofit box system 20. The box 200 is from 4.57 to 9.14 meters (15 to 30 feet) in length, 0.91 to 2.13 meters (3 to 7) feet in width, and 0.91 to 2.13 meters (3 to 7 feet) in height. The box 200 may be made of a non-corrosive material such as stainless steel, metal alloys, or the like.

FIG. 14A represents a side view of the box 200 of the retrofit box system 20. The box 200 includes a deployment chamber 202, at least one wash chamber 204, a lid 206, two or more legs 208, a waste discharge pipe 210, and one or more apertures 212. The deployment chamber 202 of the box 200 having a deployment chamber interior volume is in fluid communication with the inaccessible floor 602 via the gate complex 300. The deployment chamber 202 is configured to hold, deploy, and receive the cleaner 400.

The at least one wash chamber 204 is configured to receive seepage of waste from the deployment chamber 202 during cleaning of the inaccessible floor system 600 as pressure between the box 200 and inaccessible floor system 600 maintains equilibrium, while minimizing seepage from the retrofit box system 20 during cleaning. The at least one wash chamber 204 is adjacent to the deployment chamber 202 distal to the inaccessible floor 602. The at least one wash chamber 204 having at least one wash chamber interior volume is in fluid communication with the deployment chamber interior volume of the deployment chamber 202 as shown in FIG. 14B. As the deployment chamber interior volume fills with waste, waste will move into the at least one wash chamber interior volume via one or more wash chamber apertures 216 (see FIG. 14B), providing equilibrium between the box 200 and the inaccessible floor system 600. Preferably, there are two or more wash chambers 204, where each wash chamber 204 is adjacent to the next wash chamber 204. For example, in the event that the wash chamber 204 directly adjacent to the deployment chamber 202 fills with waste, the next directly adjacent wash chamber 204 will begin to receive waste to maintain the equilibrium between the box 200 and the inaccessible floor system. The at least one wash chamber 204 is from 15.24 to 45.72 centimeters (6 to 18) inches in length, and is substantially the same height and width as the deployment chamber 202.

The lid 206 of the box 200 seals the at least one box 200 during use of the cleaner 400. The box 200 allows liquid to enter the box interior volume of the deployment chamber 202 to equalize fluid pressure of the retrofit box system 20 with the inaccessible floor system 600, where the liquid remains in the retrofit box system 20 during cleaning as the lid 206 seals the box 200. The lid 206 is substantially the same length and width as the box 200. The lid 206 is removably attached to a top the box 200 to seal the box 200, such as through bolts, screws, or combinations thereof. The lid 206 may be made of a non-corrosive material such as stainless steel, metal alloys, or the like. The lid 206 may be apportioned into separate pieces to cover the deployment chamber 202 and the at least one wash chamber 204, for respective removable attachment.

The two or more legs 208 of the box 200 are configured to place the box 200 at a height where the cleaner 400 may be deployed to the inaccessible floor 602 of the inaccessible floor system 600. The two or more legs 208 are in mechanical communication with a bottom of the box 200, such as through welding, bolts, rivets, or the like. The two or more legs 208 may be of any non-corrosive material, such as stainless steel, metal alloys, or the like. The two or more legs 208 may include concrete fittings at their bottoms to increase stability of the two or more legs 208.

The waste discharge pipe 210 of the box 200 is configured for removal of waste from the deployment chamber 202 and the at least one wash chamber 204 of the box 200 after cleaning of the inaccessible floor system 600. The waste discharge pipe 210 is in mechanical communication with the exterior of the box 200, and provides fluid communication with the box interior volume (deployment chamber interior volume and at least one wash chamber interior volume) at the deployment chamber 202 and the at least one wash chamber 204, such as via one or more waste apertures. The waste discharge pipe 210 may be of any non-corrosive material, such as stainless steel, metal alloys, or the like.

The one or more apertures 212 are configured to accommodate power lines 510 and waste discharge lines 408 for connection to the cleaner 400. The one or more apertures 212 are formed from the at least one wash chamber 204 most distal to the inaccessible floor 602.

FIG. 14B is a transparent perspective view of the box 200 of the retrofit box system 20. As shown in FIG. 14B the at least one wash chamber 204 includes a sloped floor 218 configured to move waste toward the waste discharge pipe 210. The at least one wash chamber 204 includes at least one wash chamber aperture 216 configured to allow connection of the power lines 510 and the waste discharge lines 408 to the cleaner 400 in the deployment chamber 202. The at least one wash chamber aperture 216 further provides fluid communication between the deployment chamber box volume and the at least one wash chamber box volume. The at least wash chamber aperture 216 may include a grommet fitting to reduce wear and tear of the at least one hose of the cleaner 400.

The at least one wash chamber 204 includes a track roller system 214. The track roller system 214 is configured to facilitate deployment of the power lines 510 and the waste discharge lines 408 during cleaning to reduce strain on the at least one wash chamber aperture 216 and at least one aperture 212 (e.g. bushings of the grommets).

The box 200 may further include a winch 220 in the box interior volume configured for retrieving the cleaner 400 from the inaccessible floor 602 when the cleaner 400 becomes stuck during use.

FIG. 15 represents the gate complex. The gate complex 300 of the retrofit box system 20 is configured to provide the cleaner 400 with access to the inaccessible floor 602 of the inaccessible floor system 600. The gate complex 300 separates the deployment chamber 202 of the box 200 from the inaccessible floor 602. The gate complex 300 includes a gate 319, a gate shield 317, and a gate controller 318. The gate 319 of the at least one gate complex 300 separates the inaccessible floor 602 from the deployment chamber 202 of the box 200 hindering fluid communication when in a closed position. When in an open position (as shown), the at least one gate 319 allows fluid communication between inaccessible floor 602 and the interior volume of the deployment chamber of the deployment chamber 202, and provides access to inaccessible floor 602 for the cleaner 400.

The gate controller 318 opens and closes the gate 319, such as via a single cylinder hydraulic drive motor, an electric motor, or a manual hydraulic control. The at least one gate complex 300 may include a gate shield 317 that substantially receives the gate 319 when it is open to protect it from damage. The gate shield 317 prevents seepage from the retrofit box system 20, when the gate 319 is in an open position. The gate shield 317 may be of any non-corrosive material such as stainless steel, metal alloys, or the like.

FIG. 16 illustrates the cleaner 400 as received by the box 200. The cleaner 400 is configured to remove waste from the inaccessible floor 602 of the floor system 600. The cleaner 400 includes a drive 402, an auger 404, a slurry pump 406, and the waste discharge lines 408. The drive 402 is configured for motive actions of the cleaner 400 along the floor 602 of the floor system 600. The auger 404 is configured to disturb waste on the floor 602. The slurry pump 406 is configured to pump waste from the inaccessible floor 602 to the waste discharge lines 408. For example, the cleaner may be a remote operated vehicle, such as a Mud Cat™ ROV model SRD-6E ROV.

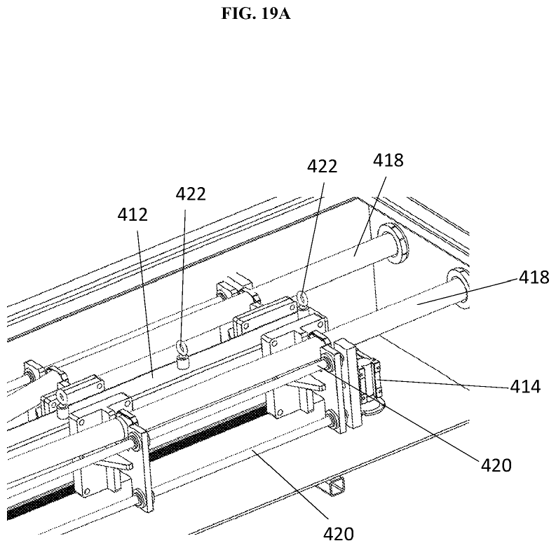

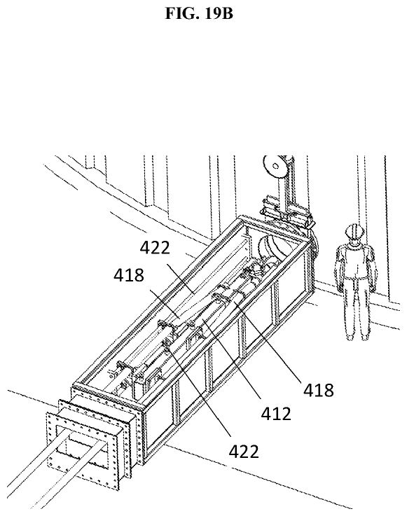

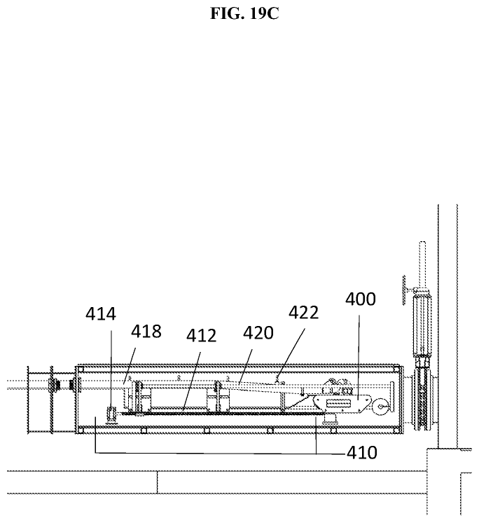

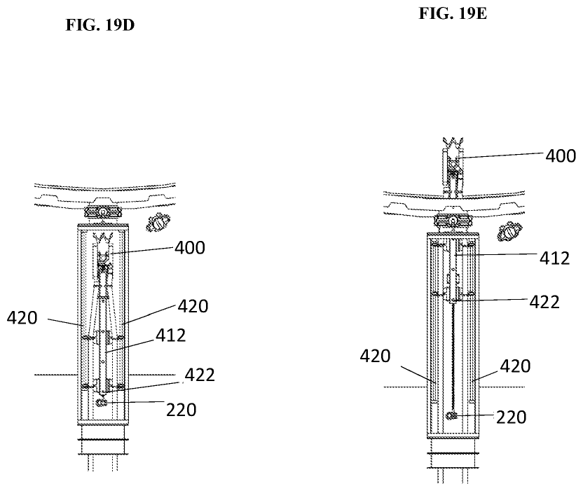

The retrofit box system 20 may further include a transfer carriage 410 as represented in FIGS. 19A-19E, the transfer carriage 410 configured to deploy the cleaner 400 from the box 200 through the gate complex 300 to the inaccessible floor system 600, such as through horizontal and vertical movement of the cleaner 400. The transfer carriage 410 is in removable attachment with the cleaner 400 and mechanical communication with the box 200. The transfer carriage 410 includes a carriage 412, a drive screw motor 414, and a winch 220, transfer tubes 418, and guide rods 420 (see FIGS. 19A-19C).

The carriage 412 of the transfer carriage 410 provides horizontal extension of the cleaner 400 in and out of the box 200 through the gate complex 300. The carriage 412 is in removable attachment to the cleaner 400, where the carriage 412 is attached to the cleaner 400 in the box 200 and through the gate complex 300 (see FIG. 19D carriage in retracted position), and the carriage 412 is not attached to the cleaner 400 when the cleaner is lowered to the inaccessible floor 602 for cleaning (see FIG. 19E carriage in extended position).

Further the carriage 412 is in sliding mechanical communication with the guide rods 420 providing for horizontal movement of the carriage 412. The carriage 412 may be an I beam having associated brackets providing the communication described herein. The carriage 412 may include one or more winch cable guides 422 configured to guide a winch cable attached to the cleaner 400 in line with the carriage 412, such that the winch cable extends straight from the winch 220 perpendicular through the gate complex 300 (see FIG. 19E).

The guide rods 420 of the transfer carriage 410 guide the carriage 412 and the attached cleaner 400 into and out of the box 200 through the gate complex 300. The guide rods 420 are in mechanical communication such as through bolts, with a side of the wash chamber 204 of the box 200 closest to the gate complex 300, and on either side of the gate complex 300 (see FIG. 19B, 19C).

The transfer tubes 418 of the transfer carriage 410 are configured for waste removal and electrical connection to the cleaner 400. For example, one of the transfer tubes 418 may be configured for waste removal and is in fluid communication with the waste discharge lines 408 of the cleaner and the waste discharge pipe 210, and the other of the transfer tubes 418 provides electrical connection from the power system 500 to the cleaner 400.

The drive screw motor 414 provides screw type extension of the carriage 412. The drive screw motor 414 may be configured to power the horizontal and vertical extension of the transfer carriage 410. The drive screw motor 414 may be a chain and sprocket electric motor. The drive screw motor 414 is mounted to the inside of the wash chamber 204 of the box 200 on a side farthest from the gate complex 300 (see FIG. 19A). The drive screw motor 414 is in electrical communication with the power system 500. The drive screw motor 414 is of a type that is explosive proof. The motor is controlled by the control system 700.

The winch 220 is configured for moving the cleaner 400 horizontally. The winch 220 may be configured to move the cleaner 400 vertically. The cable of the winch 220 extends through the winch cable guide 422. The winch 220 may be configured to move the cleaner 400 upward vertically while the cleaner 400 is in the deployment chamber 202 of the box 200. The carriage 412 then moves the cleaner 400 horizontally from the box 200 through the gate complex 300 to the floor system 600. The winch 220 may then move the cleaner 400 downward vertically until the cleaner 400 contacts the floor system 600 or the waste on the floor system 600.

FIG. 17 illustrates the power system 500 of the retrofit box system 20. The power system 500 is configured to supply power to the cleaner 400 and to pump waste from the retrofit box system 20. The power system 500 may reside on a mobile vehicle, such as a truck or semi (represented by box 800), which may be transported to the box 200. The power system 500 includes a cleaner circuit 502, a pump circuit 550, and a box circuit 560. The cleaner circuit 502 of the power system 500 is configured to power the drive 402, the auger 404, and the slurry pump 406 of the cleaner 400. The cleaner circuit 502 may further be configured to power the winch 220 and the drive screw motor 414 of the transfer carriage 410. The cleaner circuit 502 includes a power source 504, a hydraulic box 508, and power lines 510. The cleaner circuit 502 is in electric and hydraulic communication with the drive 402, the auger 404, and the slurry pump 406 via the power lines 510.

The power source 504 is engaged to generate electric power to supply electric power to the control system 700 (see FIG. 18) and the power lines 510. The power source 504 may be a diesel motor or electric generator. Simultaneously, or nearly simultaneously, the hydraulic box 508 is engaged to supply hydraulic power to the power lines 510. The power lines 510 supply power (hydraulic and electric power) to the drive 402, the auger 404, and the slurry pump 406 of the cleaner 400. The power lines 510 may further supply power to the winch 220 and the drive screw motor 414. The power lines may be transported and dispensed via a power line reel 511.

The pump circuit 550 of the power system 500 is configured to pump waste from the cleaner 400 to a disposal device 552. The pump circuit 550 includes waste discharge lines 408, a pump 556, and the disposal device 552. The waste discharge lines 408 may be transported and dispensed via a waste discharge line reel 409. The pump 556 is in fluid communication with the slurry pump 406 of the cleaner 400 via the waste discharge lines 408. The pump 556 is engaged to pump waste from the waste discharge lines 408 to the disposal device 552. The pump 556 may be powered via a diesel engine, such as a CD103M Dri-Prime® Pump. The disposal device 552 may be a semi with a liquid-carrying container to remove waste to a remote location, or the disposal device 552 may be a dewatering box to refine the waste and supply water back to the floor system 600.

The box circuit 560 of the power system 500 is configured to remove waste from the box 200 upon completion of cleaning. The box circuit 560 includes a box pump 562 and box lines 564. The box pump 562 and box lines 564 are in fluid communication with the waste discharge pipe 210 of the box 200 to remove waste upon completion of cleaning to either the disposal device 552 or the inaccessible floor system 600. The box pump 562 may be a hydraulic pump.

FIG. 18 represents the control system 700 of the retrofit box system 20. The control system 700 is configured to control the cleaner circuit 502 of the power system 500 and the cleaner 400. The control system 700 includes a control unit 702 having a signal receiver 706, a wireless controller 704, and the power lines 510. The control system 700 is in electric communication with the power system 500 to receive operating power.

The wireless controller 704 transmits a control signal to the control unit 702. The wireless controller 704 may transmit the control signal from a distance of 152.4 m (500 feet) or less from the control unit 702 allowing operation of the cleaner circuit 502 and the cleaner 400 at a distance safely away from inaccessible floor system 600. The control signal is received by a signal receiver 706 of the control unit 702, where the control unit 702 controls the cleaner circuit 502 and the cleaner 400 to engage the drive 402, the auger 404, and the slurry pump 406 via the power lines 510.

### Alternative Arrangement:

In yet another alternative arrangement, the cleaning system 10 may be the cleaning system disclosed in U.S. Provisional Application No. 63/403,545, which is hereby incorporated by reference herein in its entirety.

From the above discussion it will be appreciated that the system 10 presented herein improves upon the state of the art. Specifically, in one or more arrangements, the system 10 is presented herein which: improves upon the state of the art; is safe to operate; is relatively easy to build; is relatively friendly to build; can be built relatively quickly and efficiently; is easy to operate; is relatively cost friendly to manufacture; is relatively easy to transport; is aesthetically appealing; is robust; is relatively inexpensive; is not easily susceptible to wear and tear; has a long useful life; and/or is efficient to use and operate.

What is claimed:

1. A cleaning system for cleaning a floor of a closed system containing liquid, the system comprising:
a cleaner;
wherein the cleaner is configured to clean the floor of the closed system;
wherein the cleaner is configured to selectively enter and exit the closed system;
wherein the cleaner enters the closed system at a position located below a surface level created by the liquid within the closed system.

2. The system of claim 1, further comprising:
a gate complex;
wherein the gate complex is configured to allow selective access into the closed system;
wherein the gate complex is located below the surface level created by the liquid within the closed system.

3. The system of claim 1, further comprising:
a box system;
the box system having an interior volume;
wherein the box system is configured to operably connect to the closed system;
wherein the cleaner is initially positioned at least partially within the interior volume of the box system.

4. The system of claim 1, wherein:
a gate complex;
wherein the gate complex is configured to allow selective access into the closed system;
wherein the gate complex is located below a surface level created by the liquid within the closed system;
the gate complex having a gate;
wherein the gate is configured to be selectively moved between an open position and a closed position; and
wherein when the gate is in the open position, the cleaner is configured to enter the closed system through the gate complex located below the surface level created by the liquid within the closed system.

5. The system of claim 1, further comprising:
a gate complex;
wherein the gate complex is configured to allow selective access into the closed system;
wherein the gate complex is located below a surface level created by the liquid within the closed system;
the gate complex having a gate;
wherein the gate is configured to be selectively moved between an open position and a closed position;
a box system;
the box system having an interior volume;
wherein the box system is configured to operably connect to the gate complex;
wherein the cleaner is initially positioned at least partially within the interior volume of the box system;
wherein when the gate is in the open position, the cleaner is configured to enter the closed system through the gate complex located below the surface level created by the liquid within the closed system.

6. The system of claim 1, further comprising:
a gate complex;
wherein the gate complex is configured to allow selective access into the closed system;
wherein the gate complex is located below a surface level created by the liquid within the closed system;
the gate complex having a gate;
wherein the gate is configured to be selectively moved between an open position and a closed position;
a box system;
the box system having an interior volume;
wherein the box system is configured to operably connect to the gate complex;
wherein the cleaner is initially positioned at least partially within the interior volume of the box system;
wherein when the gate is in the open position, the cleaner is configured to enter the closed system through the gate complex located below the surface level created by the liquid within the closed system;
wherein when the gate is in the open position, liquid from within the closed system flows into the interior volume of the box system and is contained therein.

7. The system of claim 1, wherein the cleaner is attached to a waste discharge line, and wherein the waste discharge line is configured to transfer material away from the closed system.

8. The system of claim 1, wherein the cleaner is a remote controlled cleaner.

9. The system of claim 1, wherein the cleaner is an auger cleaner.

10. A cleaning system for cleaning a floor of a closed system containing liquid, the system comprising:
a gate complex;
wherein the gate complex is configured to allow selective access into the closed system;
wherein the gate complex is located below a surface level created by the liquid within the closed system;
a cleaner;
wherein the cleaner is configured to clean the floor of the closed system;
wherein the cleaner is configured to enter the closed system through the gate complex located below the surface level created by the liquid within the closed system.

11. The system of claim 10, further comprising:
a box system;
the box system having an interior volume;
wherein the box system is configured to operably connect to the gate complex;
wherein the cleaner is initially positioned at least partially within the interior volume of the box system.

12. The system of claim 10, wherein:
the gate complex having a gate;
wherein the gate is configured to be selectively moved between an open position and a closed position; and
wherein when the gate is in the open position, the cleaner is configured to enter the closed system through the gate complex located below the surface level created by the liquid within the closed system.

13. The system of claim 10, further comprising:
the gate complex having a gate;
wherein the gate is configured to be selectively moved between an open position and a closed position;
a box system;
the box system having an interior volume;
wherein the box system is configured to operably connect to the gate complex;
wherein the cleaner is initially positioned at least partially within the interior volume of the box system;
wherein when the gate is in the open position, the cleaner is configured to enter the closed system through the gate complex located below the surface level created by the liquid within the closed system.

14. The system of claim 10, further comprising:
the gate complex having a gate;
wherein the gate is configured to be selectively moved between an open position and a closed position;
a box system;
the box system having an interior volume;
wherein the box system is configured to operably connect to the gate complex;
wherein the cleaner is initially positioned at least partially within the interior volume of the box system;
wherein when the gate is in the open position, the cleaner is configured to enter the closed system through the gate complex located below the surface level created by the liquid within the closed system;
wherein when the gate is in the open position, liquid from within the closed system flows into the interior volume of the box system and is contained therein.

15. The system of claim 10, wherein the cleaner is attached to a waste discharge line, and wherein the waste discharge line is configured to transfer material away from the closed system.

16. The system of claim 10, wherein the cleaner is a remote controlled cleaner.

17. The system of claim 10, wherein the cleaner is an auger cleaner.

18. A cleaning system for cleaning a floor of a closed system containing liquid, the system comprising:
a gate complex;
wherein the gate complex is configured to allow selective access into the closed system;
wherein the gate complex is located below a surface level created by the liquid within the closed system;
a box system;
the box system having an interior volume;
wherein the box system is configured to operably connect to the gate complex;
a cleaner;
wherein the cleaner is configured to clean the floor of the closed system;
wherein the cleaner is initially positioned at least partially within the interior volume of the box system;
wherein the cleaner is configured to enter the closed system through the gate complex located below the surface level created by the liquid within the closed system.

19. The system of claim 18, wherein:
the gate complex having a gate;
wherein the gate is configured to be selectively moved between an open position and a closed position; and
wherein when the gate is in the open position, the cleaner is configured to enter the closed system through the gate complex located below the surface level created by the liquid within the closed system.

20. The system of claim 18, further comprising:
the gate complex having a gate;
wherein the gate is configured to be selectively moved between an open position and a closed position;
wherein when the gate is in the open position, the cleaner is configured to enter the closed system through the gate complex located below the surface level created by the liquid within the closed system.

21. The system of claim 18, further comprising:
the gate complex having a gate;
wherein the gate is configured to be selectively moved between an open position and a closed position;
wherein when the gate is in the open position, the cleaner is configured to enter the closed system through the gate complex located below the surface level created by the liquid within the closed system;
wherein when the gate is in the open position, liquid from within the closed system flows into the interior volume of the box system and is contained therein.

22. The system of claim 18, wherein the cleaner is attached to a waste discharge line, and wherein the waste discharge line is configured to transfer material away from the closed system.

23. The system of claim 18, wherein the cleaner is a remote controlled cleaner.

24. The system of claim 18, wherein the cleaner is an auger cleaner.
